(19) United States
(12) Patent Application Publication
(10) Pub. No.: US 2006/0080461 A1
(43) Pub. Date: Apr. 13, 2006

(54) Packet exchange for controlling system power modes

(76) Inventors: Jeffrey R. Wilcox, Folsom, CA (US); Shivnandan Kaushik, Portland, OR (US); Stephen H. Gunther, Beaverton, OR (US); Devadatta V. Bodas, Federal Way, WA (US); Siva Ramakrishnan, Beaverton, OR (US); Bernard J. Lint, Mountain View, CA (US); Lance E. Hacking, Austin, TX (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/859,656

(22) Filed: Jun. 2, 2004

(51) Int. Cl. G06F 15/173

(52) U.S. Cl. 709/238

(57) ABSTRACT

A method is described that, in order to change an operational state of a resource within a computing system that is shared by components of the computing system so that the computing system's power consumption is altered, sends a packet over one or more nodal hops within a packet based network within the computing system. The packet contains information pertaining to the power consumption alteration.

### FIELD OF INVENTION

The field of invention relates generally to computing systems; and, more specifically, to packet exchanges for controlling computer system power modes.

### BACKGROUND

Computing system comprise multiple components that may share a certain resource within the computing system. For example, referring to FIG. 1, a multiprocessor computing system is shown having four processors 101₁-101₄. Each of the processors are clocked with the same the same clock source 102. In this case, processors 101₁-101₄ are the “computing system components” and the clock source 102 is the shared resource.

Power management has become an increasingly important computing system feature. Power management is the functional aspect of a computing system that is devoted to modulating the computing system's power consumption in light of its usage. For example, because the traditional technology that has been used to implement large scale integration semiconductor chips (a technology known as Complementary MOSFET or “CMOS”) increases its power consumption with clock speed, prior art processors have been heretofore designed to modulate the speed of their clock in light of processing demand. That is, when the processing demand placed on the processor drops, the processor causes its clock to reduce its frequency; and, when the processing demand placed on the processor increases, the processor causes its clock to increase its frequency.

When a resource such as a clock source 102 is shared, changing an operational state of the shared resource to control power consumption becomes complicated because of the dependencies that exist. That is, using the circuitry of FIG. 1 as an example, if processor 101₂ desires to lower the frequency of clock source 102 because processor 101₂ has experienced a drop in processing demand, some form of investigation should be communicated amongst the processors and whatever centralized or distributed entity controls the frequency of clock source 102 to ensure that a change in the clock source 102 frequency does not adversely affect the performance of the other processors.

Moreover, power control features have been relatively isolated functions so as to involve only a few components (e.g., a single processor, a chipset, etc.) that are integrated onto the same physical platform (e.g., the same PC board and/or chassis). Therefore, power control features have traditionally been a “low-level” function implemented with only simplistic circuitry (e.g., electrically conductive signal lines designed into the physical platform whose sole purpose is to transport power control related information).

The emergence of distributed and/or scalable computing systems challenges these traditions. Specifically, distributed computing (which is the implementation of a computing system having multiple components distributed across different physical platforms that are interconnected by a network and/or having multiple components distributed across different clock domains) raises the possibility that the components that share a resource whose operational state is to be modulated in response to the computing system's usage may reside on different physical platforms. Moreover, with respect to the communication exchanges amongst components discussed above to implement an operational state change to a shared resource, the notion of scalability raises the notion that these exchanges may not be practicable if the number of components exceeds beyond some maximum threshold.

### FIGURES

The present invention is illustrated by way of example and not limitation in the figures of the accompanying drawings, in which like references indicate similar elements and in which:

FIG. 1 shows a depiction of processors sharing a clock source;

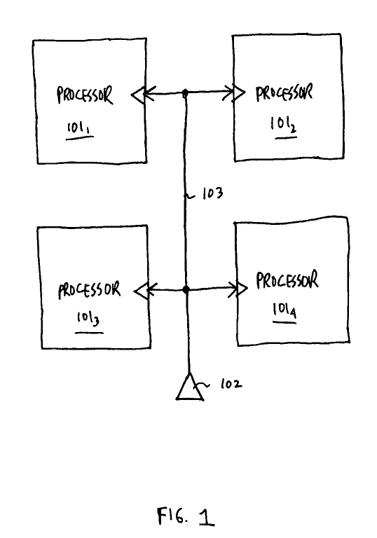

FIG. 2 shows a depiction of components from a computing system that share a resource of the computing system, where, the components are interconnected through a packet network;

FIGS. 3a and 3b show different packet based network topologies for communicating control information for modulating the power consumption of a computing system;

FIG. 4 shows an embodiment where the operational state of a shared resource whose operational state is controlled through a computing system component that shares the shared resource with other components of the computing system;

FIG. 5 shows a shared resource that controls its own operational state;

FIG. 6 shows a process for controlling the operational state of a shared resource in light of power consumption considerations amongst components of a computing system components that communicate through a packet based network;

FIG. 7 shows one embodiment of the methodology of FIG. 6;

FIG. 8 shows a depiction of components from a distributed computing system that share a resource of the distributed computing system, where, the components are interconnected through a packet network.

### DETAILED DESCRIPTION

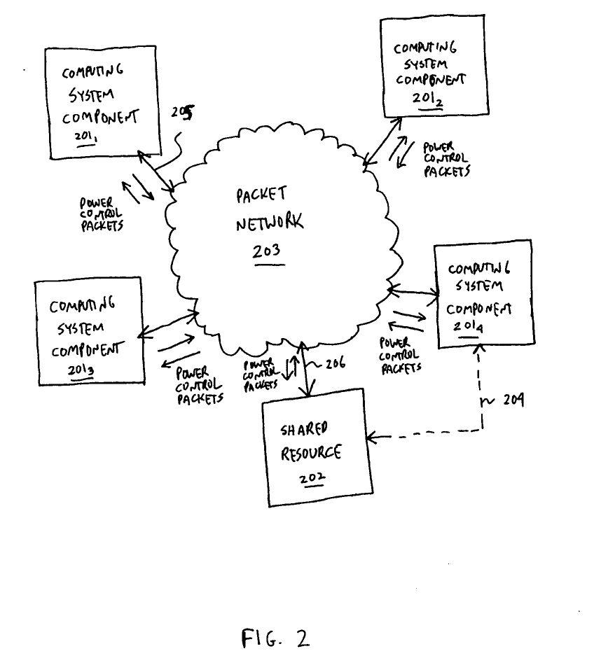

FIG. 2 shows a depiction of components 201₁ through 201₄ from a computing system that share a resource 202 of the computing system 201₁ through 201₄; where, the components 201₁ through 201₄ are interconnected through a packet network 203 at least for purposes of exchanging power management packets (i.e., packets that contain information to implement the computing system's power management function) so that the operational state of the shared resource 202 can be modulated in light of the computing system's usage.

Here, as described in more detail further below, a packet based network 203 is understood to include multiple nodes; such that, at least for some packets sent into the network at any of a number of ingress points, traversing the network to an appropriate network egress point entails one or more “nodal hops” within the network between the ingress point and the egress point. Such a packet based network 203 is significant in a number of respects concerning both common physical platform implementations and non common physical platform implementations. For simplicity, the present application will refer to a packet based network as described above simply as “a network”.

Common physical platform implementations are those implementations where the network 203 resides on the same PC board or in a single chassis. Non common physical platform implementations are those implementations where the network 203 couples components from different physical platforms (i.e., across different chasses). That is, for example, each of components 201₁ through 201₄ would be part of a different physical platform. A chassis is a complete “box” that surrounds one or more PC boards and has its own power supply. Other characteristics of a chassis include the circuitry that is housed by the chassis having its own crystal oscillator(s) for generating clock signals (except for those circuits designed to run on a clock provided from outside the chassis (such as a chassis for a time division multiplexed (TDM) networking box designed to run on a “network clock”)).

With respect to implementations where the network 203 resides on/in a common physical platform, the number of components that can be designed to share a common resource 202 can scale upward with little if any real practical concern of reaching some maximum limit for the power management function. With respect to implementations where the network 203 couples differing physical platforms, the number of components that can be designed to share a common resource 202 can also scale because the network 203 is apt to be designed to have the bandwidth to support fundamentally critical operations such as passing instructions and/or data between computing system components.

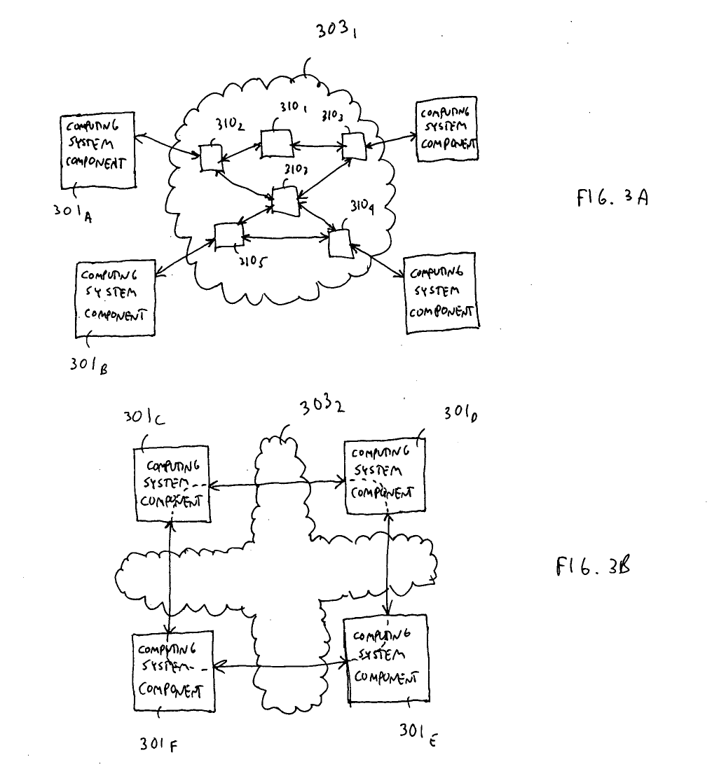

Before discussing some possible network topologies in FIGS. 3a and 3b, some additional aspects of FIG. 2 are worth note. Firstly, although four components 201₁ through 201₄ are observed, it should be understood that more than four or less than four components can also be made to share a resource within a computing system. Secondly, components are those portions of a computing system having a specific function from an architectural perspective of the computing system. A component may therefore include but is not limited to: a processor, a memory, a memory controller, a cache, a cache controller, a graphics controller, an I/O controller, an I/O device (e.g., a hard disk drive, a networking interface), a memory subsystem, etc. A component may also be a combination of components (e.g., an integrated memory controller and processor).

A resource is any functional part of a computing system such as a component or some other functional part (e.g., a clock source, a power supply, etc.). A shared resource is a resource used by more than one component. Note that FIG. 2 embraces both common and non common physical platform implementations; and, that distributed computing systems typically involve a plurality of components residing on different physical platforms and/or different clock domains. That is, distributed computing typically implements various components of the computing system with their own physical platform and interconnects them with a packet based network; and/or within their own clocking domain and interconnects them with a packet based network).

A packet based network 203, as described above, is a network designed to transport packets and having multiple nodes; where, at least for some packets sent into the network at any of a number of ingress points, traversing the network to an appropriate network egress point entails one or more “nodal hops” within the network between the ingress point and the egress point. Packets are data structures having a header and payload; where, the header includes “routing information” such as the source address and/or destination address of the packet; and/or, a connection identifier that identifies a connection that effectively exists in the network to transport the packet. Note that although packets are often viewed as a “physically connected” data structure that flows “as a single unit” along a single link, it is possible that the components of a packet data structure could be physically separated over its travels into, within and/or from the network (e.g., with a first link that carries header information and a second link that carries payload information).

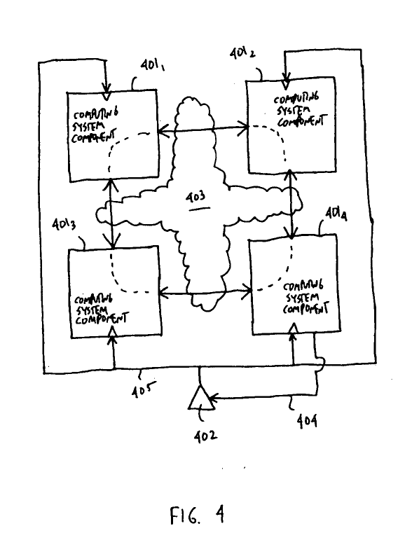

A discussion of possible exchanges of power management packets between computing system components is provided in more detail with respect to FIGS. 4, 5 and 6.

FIGS. 3a and 3b show various network topologies that packet network 203 may be comprised of. FIG. 3a shows a standard multiple node topology. FIG. 3c shows a ring topology. Here, it is to be understood that any single instance of packet network 203 may be constructed with any one or more of the network topologies of FIGS. 3a 3b (e.g., a single instance of packet network 203 may couple a first set of components with a standard topology and a second set of components with a ring topology).

FIG. 3a shows a standard packet based network 303₁. A standard packet based network can often be viewed as an ad hoc collection of nodes 310₁-310₅ at least some of which are indirectly connected to one another through another node. The nodal hop(s) are an artifact of the indirect connection(s). For example, a packet launched into the network by component 301A that is to be received by component 301B will have a “shortest path” that involves three nodal hops across nodes 310₂, 310₃ and 310₅ (because nodes 310₂ and 310₅ are indirectly connected through node 310₃). Importantly, the network nodes 310 themselves may also be components of the computing system (i.e., besides performing computing system component duties they also perform routing/switching duties).

In operation, a packet can traverse through the network (from a network ingress/source point to a network egress/destination point) by “hopping” from node to node along a path that eventually leads to the destination/egress point. Upon being received at a node, the packet's header is typically analyzed and its payload is forwarded with updated (or in some cases unchanged) header information to the next node along the path.

In a typical implementation, the nodes themselves are embedded with a “routing protocol” that enables the nodes to determine amongst themselves the appropriate node-to-node path through the network for any source/destination combination. Routing protocols are well known in the art and are typically implemented with software that runs on a processor. It is possible however that the functionality needed to execute a routing protocol could be implemented with dedicated logic circuitry in whole or in part.

FIG. 3b shows a ring topology network 303₂. An appropriately sized ring (three nodes or more with a unidirectional ring; or, four nodes or more with a bi-directional ring) can also have one or more nodal hops within the ring network. For example, a packet sent from node 301C to node 301E will experience a nodal hop at either node 301D or 301F depending on which direction the packet is sent. As the network expands in size a ring topology network (as well as a standard packet based network) can entertain at least one path having at least one nodal hop between the nodes that act as the path's ingress point into the network and the path's egress point from said network

A ring topology network often times uses a “token scheme” to control the use of the network. That is, a token is passed around the ring. A component seizes the token if it wishes to send a packet to another component. Here, the packet is released onto the ring by the sending component. The packet travels around the ring. When the packet arrives at the destination component, the destination component recognizes its address as the destination from the packet header and formally accepts the packet in response. The sending component releases the token back onto the ring when it can no longer use the ring. Rings may be unidirectional or bi-directional.

The ring topology network can be used for same physical platform implementations because it is easily scalable into any number of components and shared resources. That is, for example, a first computing system may be designed having a ring with only two components that share a certain resource, a second computing system may be designed having a ring with five components, a third computing system may be designed having a ring with ten components, etc.; where, the same software/circuitry is used in each component across all three computing systems. Moreover, a single ring can support multiple communities of components that share different resources. That is, a first set of components that share a first resource and a second set of components that share a second resource may all be coupled to the same ring within the same computing system.

A multi-physical platform, distributed computing system may be designed to use the network that transports the instructions, data and other transactions within the distributed computing system. That is, the packets that are sent as part of the power management control of the computing system uses the same network that the distributed computing system uses to transfer instructions, transfer data, request specific transactions (e.g., read, write, etc.), confirm that specific transactions have been performed, etc. . . .

In a further embodiment, the distributed computing system's underlying network includes at least one virtual network that is organized into a plurality of different channels; where, each channel type is supposed to only transport packets having a classification that corresponds to the channel type. That is, packets are classified based upon the type of content they contain; and, a unique channel is effectively designed into the network for each of the packet classes that exist (i.e., a first channel is used to transport packets of a first classification, a second channel is used to transport packets of a second classification, etc.). Here, power management packets could be assigned to one of the classes and therefore be transported along the channel allocated for the particular class.

Referring back to FIG. 2, note that at least two forms of centralized power management control are suggested. Centralized power management control is an architecture where final decision making is located at a single location, although the decisions made can be based upon information sent from other locations that share the same resource. FIG. 2 suggest that, it terms of controlling the operational state of shared resource 202 for purposes of modulating the power consumption of the computing system, the point of control can exist at either component 201₄ or at the shared resource 202 itself. If the point of control exists at component 201₄, control line 204 is used to control the operational state of shared resource 202. If the point of control is at the shared resource itself 202, the shared resource should be connected to the packet based network 203.

An example of the former (control point at component 201₄) would be if the shared resource 202 is a cache and the computing system components 201, through 201₄ are each processors that read/write cache lines worth of data from/to the cache 202; where, the cache 202 is local to processor 201₄. Here, processor 201₄ could be the control point having the circuitry and/or software for deciding what operational state cache 202 should be within in light of the usage of the computing system. An example of the later would be if the cache 202 itself ha the circuitry and/or software to make such decisions.

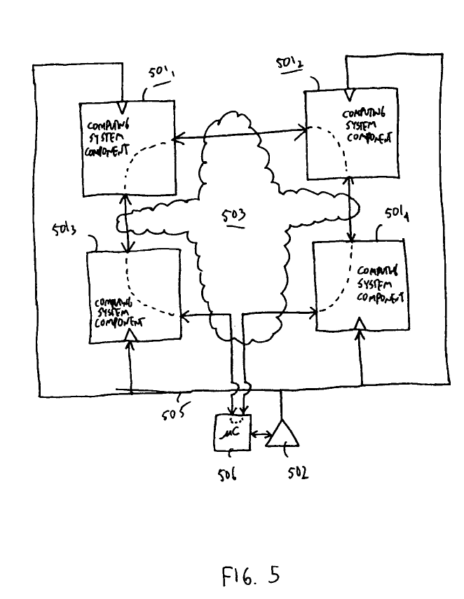

FIGS. 4 and 5 present some possibilities concerning the exchange of power management packets through a packet network within a computing system. Both FIGS. 4 and 5 involve centralized control of the shared resource. FIG. 4 shows an instance where the control of the operational state for the shared resource 402 is centralized in component 401₄. FIG. 5 shows an instance where the control of the operational state of the share resource 502 is centralized at the shared resource 502. Both the examples of FIGS. 4 and 5 show the packet based network 403, 503 as having a ring topology. It should be understood, however, that the principles presently described can be easily adapted to a standard packet based network. In both of FIGS. 4 and 5 the shared resource is a clock source 402, 502 that supplies a clock signal 405, 505 to four computing system components 401₁ through 401₄, 501₁ through 501₄.

According to FIG. 4, if a first component (e.g., component 401₂) desires to place shared resource 402 into a new operational state, it sends a request packet around the ring 403. The request packet indicates that a request is being made to change the operational state of the shared resource. Each component on the ring observes the request and forwards a response to the control point component 401₄ (e.g., “OK” to change operational state; or, “NOT OK” to change operational state). The response may take the form as a separate packet sent from each component or may be embedded into the request packet itself. Alternatively, a response packet may circulate the ring that each component is expected to embed its response into.

Regardless as to the precise nature of the packet exchange, the control point component 401₄ accumulates the responses and determines whether the operational state is acceptable or not. (e.g., if all components indicate it is “OK” to change the state; then, the change is deemed acceptable—otherwise it is not deemed acceptable). The change is made through control line 404.

The architecture of FIG. 5 could work the same way as described above with respect to FIG. 5 except that a micro-controller 506 associated with the shared resource accumulates the responses to the request packet and determines whether or not the operational state change is acceptable.

Each of the packet exchange examples discussed above indicated that a particular component that used the shared resource affirmatively requested the state change. In an alternative approach, the usage of the shared resource itself might trigger a request packet being sent from the control point for the shared resource. For example, if the shared resource 402, 502 of FIGS. 4 and 5 were a cache rather than a clock source, the control point could detect reduced usage of the cache; and, in response thereto, the control point could circulate a request packet to the components that requests their approval for an operational state change (e.g., a change to a higher power consumption and reduced response time mode or a lower power consumption and increased response time mode); or, the control point could circulate an affirmative notice to the components that the shared resource is about to change its operational state.

Each of the packet exchange examples discussed above discuss a centralized point of control for a shared resource. Conceivably the control could be distributed amongst the components themselves. For example, the components could broadcast to each other their usage of the shared resource and, by executing an identical algorithm at each component, each component could reach the same conclusion for a given set of circumstances regarding the operational state of the shared resource.

With respect to ring topologies, recalling that more than one community of resource sharing components could be connected to the same ring. That is, for example, a first set of components that share a first resource and a second set of components that share a second resource could all be coupled to the same ring. Here, components of a same set should know the identities or addresses of other components they share resources with so that destination and source addresses can be properly recognized (e.g., so that a component from the first set knows to ignore a packet sent from a component that belongs to the second set).

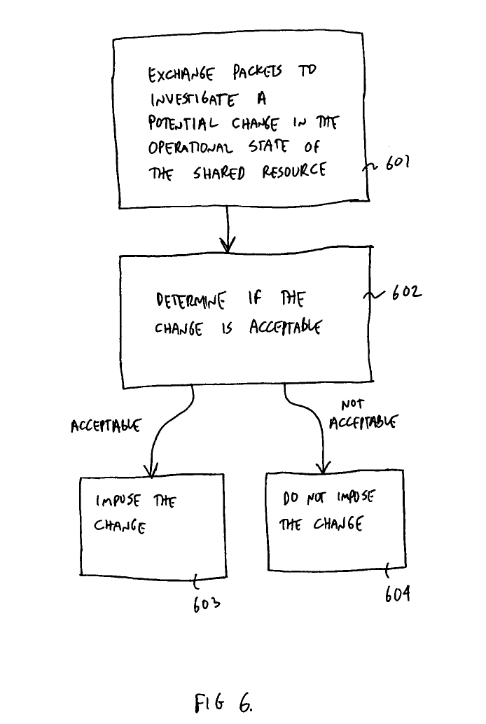

FIG. 6 shows a high level embodiment of a methodology that encompasses any of those discussed above. According to the methodology of FIG. 6, packets are exchanged to investigate a potential change in the operational state of a shared resource so that the computing system's power consumption can be regulated 601. Then a determination is made to see if the change is acceptable 602. If the change is deemed acceptable, the change is imposed 603. If the change is not deemed acceptable the change is not imposed 604.

Note that FIG. 6 is expansive in that it covers all types of network topologies such as bus, point-to-point mesh, ring and combinations thereof. Here, circulation schemes across any of these network topologies can be readily determined by those of ordinary skill for request packets that request an operational state change to the shared resource, notification packets that notify of an operational state change to the shared response, and response packets that contain a response to a request for an operational state change.

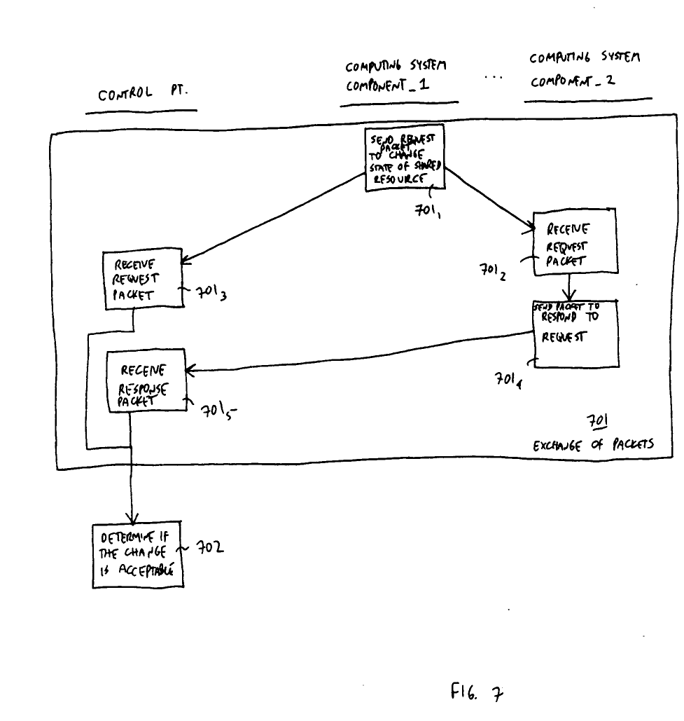

FIG. 7 shows a flow chart embodiment of a packet exchange 701. According to the flow chart of FIG. 7, a first component of a computing system sends a packet 701₁ that requests a change of operational state for a shared resource. The request reaches other computing system components that share the resource (e.g., as demonstrated by 701₂) as well as the control point for the shared resource 701₃. The computing system components respond to the request (e.g., as demonstrated by response 701₄) which are received by the control point (as represented by reception 701₅). In light of the control points reception of the request and the responses to the request, the control point can make a determination whether or not the operational state change is proper 702.

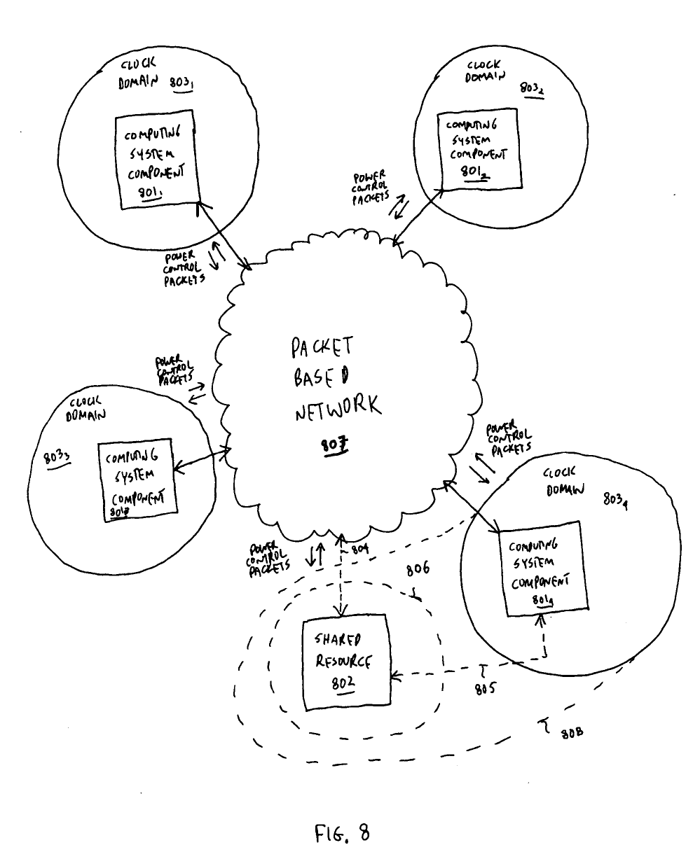

Recall from the discussion of FIG. 2 that distributed computing systems may contain different physical platforms for various components and/or different clocking domains for various components. FIG. 8 shows a distributed computing system that at least includes four different clock domains 803₁ through 803₄ for four different components 801₁ through 801₄. A clock domain includes all circuitry whose clocking is derived from the same clock source (such as a crystal oscillator). Thus, the clock that runs component 801₁ is ultimately derived from a clock source whose derivatives span region 803₁. Other components or resources may or may not reside with clock domain 803₁. The same may be said for the relationships between clock domains 803₂, 803₃, 803₄ and components 801₂, 801₃ and 801₄, respectively.

Note that if component 801₄ is the control point for the shared resource 802, clock domain 803₄ will include region 808. Control line 805 can be used to control the operational state of the shared resource 802 in this case. If the control point for the shared resource 802 is the shared resource 802 itself, it is apt to be within its own clocking domain 806.

The circuitry that actually implements the power management function may be any circuitry capable of performing the method taught herein. Examples include a state machine or embedded controller/processor that executes software instructions consistent with the methodologies taught herein—or some combination thereof. In order to launch packets onto the network and receive packets from the network the circuitry should be coupled to a media access layer (MAC) circuit. The MAC circuit includes or has an interface to coupled to the physical later circuitry that drives/receives signals on/from the physical lines of the network. The network lines can be copper or fiber optic cables that are connected to a PC board with a connector.

The software may be implemented with program code such as machine-executable instructions which cause a machine (such as a “virtual machine”, general-purpose processor or special-purpose processor) to perform certain functions. Alternatively, these functions may be performed by specific hardware components that contain hardwired logic for performing the functions, or by any combination of programmed computer components and custom hardware components.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

1. A method, comprising:
in order to change an operational state of a resource within a computing system that is shared by components of said computing system so that said computing system's power consumption is altered:
sending a packet over one or more nodal hops within a packet based network within said computing system, said packet containing information pertaining to said power consumption alteration.

2. The method of claim 1 wherein said packet based network comprises nodes having a routing protocol function.

3. The method of claim 2 wherein said packet based network comprisesat least one path having at least one nodal hop between the nodes that act as said path's ingress point into said network and said path's egress point from said network.

4. The method of claim 3 wherein said computing system is a distributed computing system.

5. The method of claim 4 wherein at least some of said components reside on different physical platforms that are communicatively coupled by said packet based network.

6. The method of claim 4 wherein at least some of said components reside within different clock domains of said computing system, the circuitry within said different clock domains communicatively coupled by said packet based network.

7. The method of claim 1 wherein said packet based network comprises a ring topology.

8. The method of claim 7 wherein said computing system is not a distributed computing system.

9. The method of claim 1 wherein said packet includes a request to change the operational state of said shared resource.

10. The method of claim 1 wherein said packet includes a response to a request to change the operational state of said shared resource.

11. The method of claim 1 wherein said packet includes notification of a change to the operational state of said shared resource.

12. The method of claim 1 wherein said shared resource is selected from the group consisting of:
a cache;
a clock source; and,
a power supply.

13. A semiconductor chip including a component for use in a computing system, comprising:
circuitry selected from the group consisting of:
a state machine;
a controller; and,
a processor,
said circuitry coupled to media access layer (MAC) circuitry, said circuitry and said MAC layer circuitry to prepare a packet for sending over one or more nodal hops within a packet based network within said computing system, said packet containing information pertaining to a change in the operational state of resource of said computing system for purposes of altering said computing system's power consumption, said resource shared by said component as well as other components within said computing system.

14. The semiconductor chip of claim 13 wherein packet based network comprises nodes having a routing protocol function.

15. The semiconductor chip of claim 13 wherein said packet based network comprises at least one path having at least one nodal hop between the nodes that act as said path's ingress point into said network and said path's egress point from said network.

16. The semiconductor chip of claim 13 wherein said packet based network comprises a ring topology.

17. The semiconductor chip of claim 13 wherein said information comprises a request to change the operational state of said shared resource.

18. The semiconductor chip of claim 13 wherein said information comprises a response to a request to change the operational state of said shared resource.

19. The semiconductor chip of claim 13 wherein said information comprises notification that a change to the operational state of said shared resource has been made.

20. The semiconductor chip of claim 13 wherein said information comprises a broadcast of usage of said shared resource.

21. A computing system comprising:
a semiconductor chip including a component for use in a computing system,
said semiconductor chip comprising:
circuitry selected from the group consisting of:
a state machine;
a controller; and,
a processor,
said circuitry coupled to media access layer (MAC) circuitry, said circuitry and said MAC layer circuitry to prepare a packet for sending over one or more nodal hops within a packet based network within said computing system, said packet containing information pertaining to a change in the operational state of resource of said computing system for purposes of altering said computing system's power consumption, said resource shared by said component as well as other components within said computing system; and,
a cable connector to connect to a copper cable, said copper cable being a physical line within said packet based network that said packet is transported over via said MAC later circuitry.

22. The computing system of claim 21 wherein packet based network comprises nodes having a routing protocol function.

23. The computing system of claim 21 wherein said packet based network comprises at least one path having at least one nodal hop between the nodes that act as said path's ingress point into said network and said path's egress point from said network.

24. The computing system of claim 21 wherein said computing system is a distributed computed system.

25. The computing system of claim 21 wherein said packet based network comprises a ring topology.

26. The computing system of claim 25 wherein said computing system is not a distributed computing system.

27. The computing system of claim 21 wherein said information comprises a request to change the operational state of said shared resource.

28. The computing system of claim 21 wherein said information comprises a response to a request to change the operational state of said shared resource.

29. The computing system of claim 21 wherein said information comprises notification that a change to the operational state of said shared resource has been made.

30. The computing system pf claim 21 wherein said information comprises a broadcast of usage of said shared resource.
